(19) United States
(12) Patent Application Publication
(10) Pub. No.: US 2008/0034084 A1
(43) Pub. Date: Feb. 7, 2008

(54) Method, system and program product for monitoring client programs in a client-server environment

(75) Inventor: Nikhil Pandya, Fortworth, TX (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/499,269

(22) Filed: Aug. 4, 2006

(51) Int. Cl. G06F 15/173

(52) U.S. Cl. 709/224

(57) ABSTRACT

A method, system, and program product for monitoring client programs in a client-server environment are provided. Specifically, under the present invention, a client program on each of a set (e.g., at least one) of clients connected to a server is monitored with a monitoring program. The monitoring program is loaded on a problem detection computer, and as part of the monitoring operation, the monitoring program monitors each of a set of connection components to/through which the client-server connections are maintained. When a problem with an operation of one of the client programs is detected with the monitoring program, characteristics of the problem will be analyzed. Based on the analysis, an organizational group to resolve the problem will be selected

### BACKGROUND OF THE INVENTION

1. Field of the Invention

The present invention generally relates to a predictive testing utility. Specifically, the present invention relates to a method, system and program product for monitoring client programs in a client-server environment.

2. Related Art

As Information Technology (IT) infrastructures become more sophisticated, the challenges associated with monitoring client-server connections continue to mount. In one current embodiment, clients connect to a server through one or more connection components. One technology that is popular with which such an embodiment can be implemented is Siebel in which the connection components are Siebel components (Siebel and all Siebel-based trademarks are trademarks of Oracle, Inc. in the United, States, other countries, or both). Unfortunately, client-server connections are known to occasionally fail. That is, a certain connection component that is maintaining one or more client connections to the server could go into a state of failure. When this occurs, the associated client-server connections will fail. To date, such connection problems have typically been cycled through a series of groups within the organization responsible for the client server connections. For example, the problem might be a developer problem, a networking problem, etc. One problem is that no existing technology is capable of analyzing the problem and routing it to the correct group for correction. That is, current problems are often incorrectly or under-analyzed and routed to the incorrect group.

In view of the foregoing, there exists a need for an approach that solves at least one of the deficiencies of the existing art.

### SUMMARY OF THE INVENTION

In general, the present invention provides a method, system, and program product for monitoring client programs in a client-server environment. Specifically, under the present invention, a client program on each of a set (e.g., at least one) of clients connected to a server is monitored with a monitoring program. The monitoring program is loaded on a problem detection computer, and as part of the monitoring operation, the monitoring program monitors each of a set of connection components to/through which the client-server connections are maintained. In one embodiment, the connection components are Siebel components and the client program(s) are Javabean programs that contain a subset of code from a larger Java bean program (Java and all Java-based trademarks are trademarks of Sun Microsystems, Inc. in the United, States, other countries, or both). However, this need not be the case. Rather, the present invention could be implemented in conjunction with any type of connection components or program language.

In any event, when a problem with an operation of one of the client programs is detected with the monitoring program, characteristics of the problem will be analyzed. Based on the analysis, an organizational group to resolve the problem will be selected. In general, the organizational group selected will be one or more of the following groups: a developer group, a networking group, an environment group, or an administrator group. Along these lines, the present invention provides a predictive monitoring function in that a status of the set of connection components on the server is monitored for potential failure. A connection failure of one of the set of clients is avoided by switching from a potentially failing connection component to a functioning connection component (i.e., prior to actual failure of the potentially failing connection component). Switching connection components can include switching to a connection component on the same server, or to a connection component on another server.

A first aspect of the present invention provides a method for monitoring client programs in a client-server environment, comprising: monitoring a client program on each of a set of clients with a monitoring program loaded on a problem detection computer, wherein each of the set of clients connects to one of a set of connection components on a server; detecting a problem with an operation of one of the client programs with the monitoring program; analyzing characteristics of the problem with the monitoring program; and selecting an organizational group to resolve the problem based on the analyzing.

A second aspect of the present invention provides a system for monitoring client programs in a client-server environment, comprising: a system for monitoring a client program on each of a set of clients with a monitoring program loaded on a problem detection computer, wherein each of the set of clients connects to one of a set of connection components on a server; a system for detecting a problem with an operation of one of the client programs with the monitoring program; a system for analyzing characteristics of the problem with the monitoring program; and a system for selecting an organizational group to resolve the problem based on the analyzing, wherein the organizational group is selected from an organizational group consisting of a developer group, a networking group, an environment group, and an administrator group.

A third aspect of the present invention provides a program product stored on a computer useable medium for monitoring client programs in a client-server environment, the computer useable medium comprising program code for causing a computer system to perform the following steps: monitoring a client program on each of a set of clients with a monitoring program loaded on a problem detection computer, wherein each of the set of clients connects to one of a set of connection components on a server; detecting a problem with an operation of one of the client programs with the monitoring program; analyzing characteristics of the problem with the monitoring program; and selecting an organizational group to resolve the problem based on the analyzing, wherein the organizational group is selected from an organizational group consisting of a developer group, a networking group, an environment group, and an administrator group.

A fourth aspect of the present invention provides a method for monitoring client programs in a client-server environment, comprising: providing a computer infrastructure being operable to: monitor a client program on each of a set of clients with a monitoring program loaded on a problem detection computer, wherein each of the set of clients connects to one of a set of connection components on a server; detect a problem with an operation of one of the client programs with the monitoring program; analyze characteristics of the problem with the monitoring program; and select an organizational group to resolve the problem based on the analyzing, wherein the organizational group is selected from an organizational group consisting of a developer group, a networking group, an environment group, and an administrator group.

A fifth aspect of the present invention provides a business method for monitoring client programs in a client-server environment.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative architectural diagram in accordance with the present invention.

FIG. 2 depicts a more detailed diagram of the monitoring program of FIG. 1

FIG. 3 depicts a method flow diagram according to a first illustrative scenario of the present invention.

FIG. 4 depicts a continuation of the method flow diagram of FIG. 3.

FIG. 5 depicts a method flow diagram according to a second illustrative scenario of the present invention.

FIG. 6 depicts a continuation of the method flow diagram of FIG. 3.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and program product for monitoring client programs in a client-server environment. Specifically, under the present invention, a client program on each of a set (e.g., at least one) of clients connected to a server is monitored with a monitoring program. The monitoring program is loaded on a problem detection computer, and as part of the monitoring operation, the monitoring program monitors each of a set of connection components to/through which the client-server connections are maintained. In one embodiment, the connection components are Siebel components and the client program(s) are Java bean programs that contain a subset of code from a larger Java bean program. However, this need not be the case. Rather, the present invention could be implemented in conjunction with any type of connection components or program language.

In any event, when a problem with an operation of one of the client programs is detected with the monitoring program, characteristics of the problem will be analyzed. Based on the analysis, an organizational group to resolve the problem will be selected. In general, the organizational group selected will be one or more of the following groups: a developer group, a networking group, an environment group, or an administrator group. Along these lines, the present invention provides a predictive monitoring function in that a status of the set of connection components on the server is monitored for potential failure. A connection failure of one of the set of clients is avoided by switching from a potentially failing connection component to a functioning connection component (i.e., prior to actual failure of the potentially failing connection component). Switching connection components can include switching to a connection component on the same server, or to a connection component on another server.

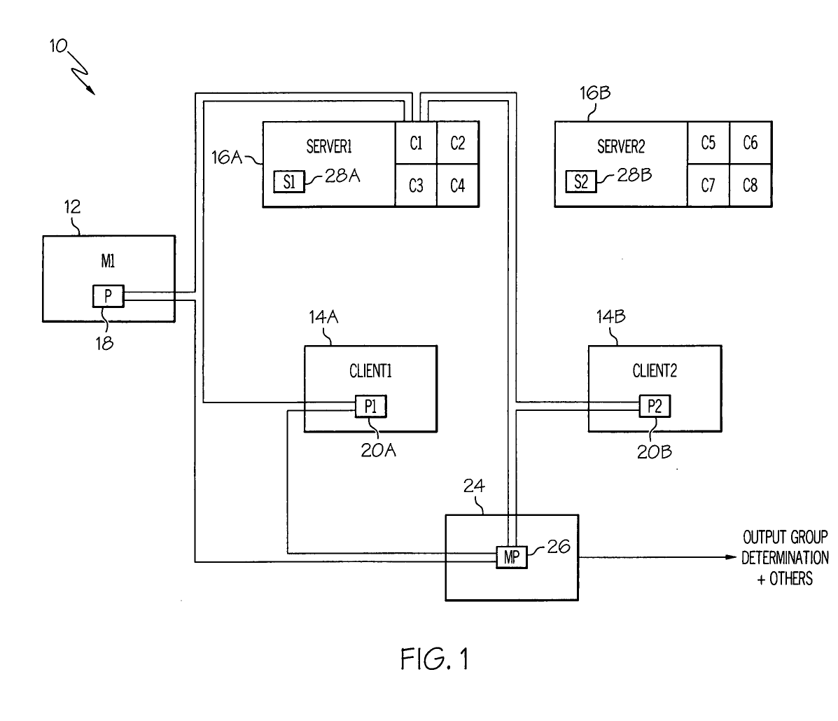

Referring now to FIG. 1, an architectural diagram 10 according to the present invention is shown. As depicted, computer systems such as machine 12, and clients 14A-B connect to a server 16A via connection components C1-C4 (four connection components C1-C4 are shown for illustrative purposes only). As indicated above, connection components are typically Siebel connection components, but this need not be the case. In any event, machine 12 and clients 14A-B each have a client (e.g., connection) program for facilitating a connection with connection components C1-C4 of server. Specifically, machine 12 is shown including client program 18, while clients 14A-B are shown including client programs 20A-B. In a typical embodiment, machine 12 is a production server machine (e.g., running a web server application), while clients 14A-B need not be. To this extent, machine 12 and client 14A are typically on a different network than client 14B. This allows a problem with machine and/or client 14A, to be verified by examining client 14B, which might not have the same problem because it is on a different network (and vice versa).

Client programs 18 and 20A-B establish a connection with a connection component C1-C4 on server 16A (connections with connection component C1 are shown for illustrative purposes only; any connection component could be utilized). In general, server 16A and connections thereto are managed by one or more server programs 28A, which could also communicate with monitoring program 26 under at least one scenario of the present invention. As also shown in FIG. 1, the present invention could also utilize one or more other servers 16B, that has its own server program 28B and connection components C5-C8. As will be further described below, connections with server 16A could be changed to server 16B in the face of errors. Also, server 16B can provide a basis for comparison for the operation of server 16A. To this extent, server programs 28A-B could be monitored directly by monitoring program 26 in one embodiment of the present invention.

In any event, client programs 18 and 20A-B are Javabean programs that include technology from known client programs as well as additional technology provided under the present invention. This additional technology is leveraged under the present invention by monitoring program 26 to predict and/or detect problems with connections (e.g., login attempts) to server 16A. To this extent, client programs 20A-B are subsets of client program 18. In general, client program 18 can interact with any type of application on machine 12. For example, assume in an illustrative example that machine 12 implements a financial application that obtains data from Siebel using client program 18. In such a case, the success of the financial application is dependent on the operation of client program 18.

Shown below is illustrative code that could be implemented within or in conjunction with client program 18:

import com.siebel.data.*;
...
SiebelDataBean m_dataBean = null;
SiebelBusObject sbo_busObject = null;
SiebelBusComp sbc_busComp = null;
try {
boolean result;
...
String userLoginName =...
String strJdbLoginUser=...
String strJdbLoginPwd =...
...
m_dataBean = new SiebelDataBean( );
result = m_dataBean.login(“siebel://GatewayServer/
EnterpriseName/AppObjMgr/SiebelServer”,strJdbLoginUser,
strJdbLoginPwd, “enu”);
SiebelBusObject sbo_busObject
= m_dataBean.getBusObject(“Contact”);
SiebelBusComp sbc_busComp =
sbo_busObject.getBusComp(“Contact”);
sbc_busComp.setViewMode(3);
sbc_busComp.clearToQuery( );
sbc_busComp.activateField(“First Name”);
sbc_busComp.activateField(“Last Name”);
sbc_busComp.activateField(“Id”);
sbc_busComp.setSearchSpec(“Login Name”,userLoginName);
sbc_busComp.executeQuery2(true,true);
”
if (sbc_busComp.firstRecord( )) {
System.out.println(“Contact ID:
“+sbc_busComp.getFieldValue(“Id”)+”; First
Name:”+sbc_busComp.getFieldValue(“First Name”)+ ” ;Last
Name:”+sbc_busComp.getFieldValue(“Last Name”));
}
sbc_busComp.release( );
sbo_busObject.release( );
m_dataBean.logoff( );
} catch (SiebelException se) {
System.err.println(“Error:”+se.getErrorMessage( ));
se.printStackTrace( );
}

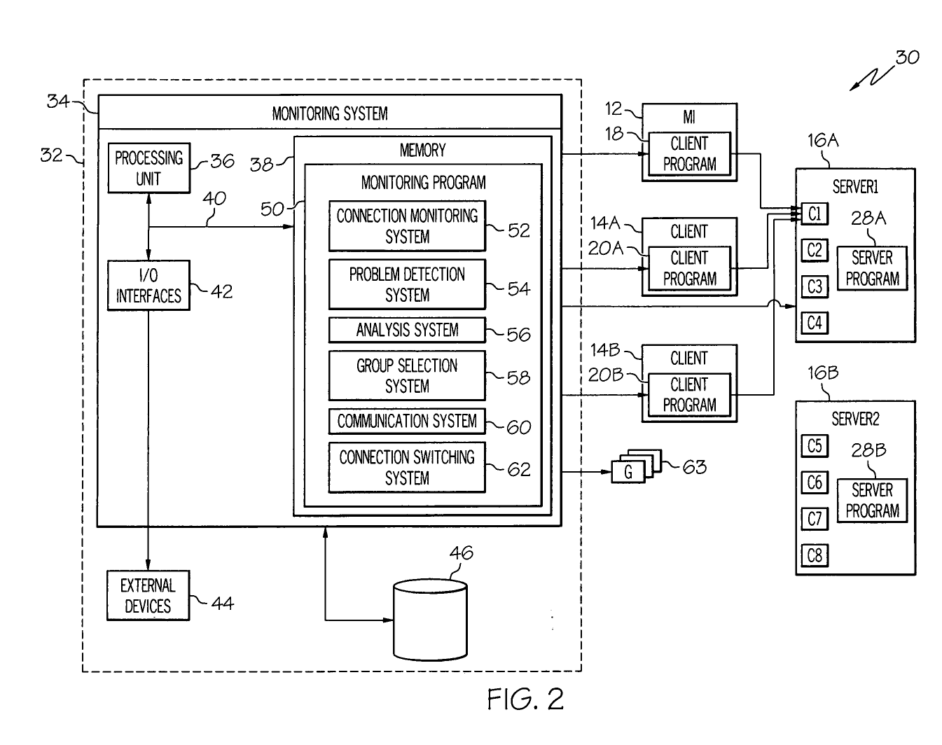

As further shown in FIG. 1 is monitoring (computer) system 24, which includes monitoring program 26. In a typical embodiment, monitoring program 26 is a combination of RMI and shell script (e.g., such as a Remote Shell Login (RSL)). Regardless, as will be further described below in conjunction with FIG. 2, monitoring program 26 monitors client programs 18 and 20A-B (e.g., a state thereof) for problems connecting to connection components C1-C4. Specifically, a connection component C1-C4 could be malfunctioning and preventing a connection by a client program 18 or 20A-B. Such a problem would be registered by client program 18 or 20A-B. Because client programs 18 and 20A-B are being monitored by monitoring program 26, the problem would be detected thereby. Once detected, characteristics of the problem will be analyzed. Based on the analysis, a particular operational group will be identified to address the problem. Specifically, the present invention will identify at least one of the following groups that is/are best suited to solve the problem: developer group, a networking group, an environment group, and an administrator group. As indicated above, it is very often the case that a problem might be a developer problem, a networking problem, an environment problem, an administrative problem, etc. The present invention will analyze the problem and make sure the appropriate group is alerted.

In general, the above-referenced groups have the following roles:

(1) Developer group: writes the code for applications and tests on development/trial machines. This group typically solves any code specific problem such as syntax errors, exceptions, incorrect business login implementation, etc.

(2) Environment group: maintains the libraries needed to run the applications. Maintain classpath, library path, shell variables etc. This group knows what is needed to run the application successfully. For example, this group would answer questions such as: which version of jar files are needed for application, C libraries; which version of Application server, db2 server, web server are needed; which version of a tool is needed; from which directory the applications should be run; what Internet Protocol (IP) configurations are needed; what DSN names should be set for applications to run on machine. This group performs tasks and/or solves problems such as setting new libraries when applications are upgraded; setting new path variables when applications upgrade; and identifying the parameter settings needed to run on machines. For example if an application uses a parameter DSN name, and it is not defined in the environment of user, the application would not run. As such, the environment should be set by the environment group.

(3) Administrator (Application) group: This refers to the administrator of an application server (e.g., a Siebel Administrator). Specifically, a Siebel administrator takes care of the components that are run on the application server and determines information such as: which tasks can be run on the application server; who would be the users of the system; etc. This Administrator is typically specific to Siebel and as such, is different from a system administrator who would be contacted if the machine itself has crashed or in case of similar problems. For the purposes of this invention, it is assumed that the machine has not crashed. Along these lines, the Administrator solves problems such as any component has crashing.

(4) Network group—when enterprise applications are deployed at different geographies—traffic passes through various routers and bridges—different ports are enabled on machines to permit/restrict access. If the packets (e.g., request from client to server) does not pass through the connections—the network group would be called in.

As another feature of the present invention, monitoring program 26 provides a predictive problem detection function. That is, based on its monitoring of client programs 18 and 20-B, monitoring program 26 can tell if a problem is apparent. For example, assume that based on its monitoring of client program 18, monitoring program 26 can tell that connection component C1 is about to fail or is failing. Based on this information, monitoring program 26 can predict that clients 14A-B would also have trouble connecting to connection component C1. As such, in addition to alerting the appropriate operational group, monitoring program 26 will instruct client programs 20A-B to connect to a connection component other than C1. This can be another connection component C2-C4 on server 16A, or a connection component on another server (not shown).

In general the present invention: (1) can determine which group can best solve a problem (i.e., determination); (2) can predict a possible problem (e.g., prediction); and (3) offers a possibility to correct a problem (e.g., correction). There are two illustrative scenarios that will be set forth below. These scenarios depend on whether server program 28A can be permitted to connect to monitoring program 26. If so, only machine 12, client 14A, monitoring program 26, and server program 28A are needed. If, however, due to security reasons server program 28A cannot connect directly to monitoring program 50, both clients 14A-B will be user to connect to serve 16A.

In any event, shown below is illustrative pseudo code for the various programs provided under the present invention.

```
Client program 20A on client 14A:
// t11 is telnet status - 0 is failure , 1 is success
// t12 -0 is failure, 1 is success
// p11 is status of program // 0 is failure , 1 is success
// accept SiebelServer and AppObjmgr parameters from MP to pass to Status Program
Program P1 {
  1. Listen to request from Program mp by running on a port
  // can be C program/ rmi Java or shell script
  2. when requested invoke function telnet_status( ) to get value t11, t12
  3. After step 2 is run invoke program Status and return value p11 for Appobjmgr,
    server requested by MP
  4. Run correction program if requested by MP
  }
{
telnet_status( )
{
check if command - telnet <server> <port> has been successful -
// port used here is generally 2320
if
{successful status code t11 =1}
else
{status code t11 = 0}
check if command - telnet <server> <public port> is successful
// public port say 80 (http) or 23 (telnet) which can be used by application
if
{successful status code t12 =1}
else
{ status code t12 = 0}
return ( t11, t12)
}
Program status -
// read Appobjmgr, SiebelServer from MP to try to connect to
import com.siebel.data.*;
import com.siebel.data.SiebelException;
public class Status{
    static boolean val=false;
    static int p11=0;
  public static int code( siebelserver , appobjmgr) {
    SiebelDataBean m_dataBean = new SiebelDataBean( );
    try {
val=m_dataBean.login(“siebel.tcpip.none.none://GatewayServer:<port>/EnterpriseName/
” + appobjmgr +“, siebelserver , +
“userid”,“password”,“lang”);
      if(val )
          System.out.println(“Successful Connection”);
          p11=1;
        m_dataBean.logoff( );
    m_dataBean=null;
      return(p11);
      }
}
Client program 20B on client 14B:
Client program 20B is similar to client program 20A, but it runs on a device (i.e., client
14B). As such, status code is returned to t21, t22 and p22.
// determine which AppObjMgr, SiebelServer has MP requested for use that in the
program below
Program P2{
  1 Listen to request from Program mp by running on a port
  // can be C program/ rmi Java or shell script
  2 when requested invoke function telnet_status( ) to get value t21, t22
  3  After step 2 is run invoke program Status with Server and Appibjmgr parameters
      and return value p22
  }
telnet_status( )
{
check if command - telnet <server> <port> has been successful -
if
{successful status code t11 =1}
else
{ status code t11 = 0}
check if command - telnet <server> <public port> is successful
if
{successful status code t22=1}
else
{ status code t2 = 0}
return ( t21, t22 );
}
Program status -
// read Appobjmgr, SiebelServer from MP to try to connect to
Program status -
// read Appobjmgr, SiebelServer from MP to try to connect to
import com.siebel.data.*;
import com.siebel.data.SiebelException;
public class Status{
    static boolean val=false;
    static int p22=0;
  public static int code( siebelserver, appobjmgr) {
    SiebelDataBean m_dataBean = new SiebelDataBean( );
    try {
val=m_dataBean.login(“siebel.tcpip.none.none://GatewayServer:<port>/EnterpriseName/
” + appobjmgr +“, siebelserver , +
“userid”,“password” ,“lang”);
      if(val )
          System.out.println(“Successful Connection”);
          p11=1;
        m_dataBean.logoff( );
    m_dataBean=null;
      return(p22);
      }
}
Server program 28A on server 16A:
(in only one server environment - we will name it s1 if it is multi server environment,
and if we need the ability to correct the problem - if found)
{
  1 Listen to request from Program mp by running on a port
  // can be C program/ rmi Java or shell script
  2 when requested determine which component is to be checked
Login to server manger as administrator // command - srvrmgr /g gateway1 /e enterprise1
/s server1 /u sadmin /p sadmin
  3 list online components > redirect to a file f1
  4 grep from the list if desired component/ objmgr requested from MP exists in f1 //
    grep “<component>” f1
  5 If
  {the component exists send the output s=1 to mp }
  else
  {send the status s1=0 to mp }
}
Server program 28B on Server 16B:
{
  1 Listen to request from Program mp by running on a port
  // can be C program/ rmi Java or shell script
  2 when requested determine which component is to be checked
Login to server manger as administrator // command - srvrmgr /g gateway1 /e enterprise1
/s server1 /u sadmin /p sadmin
  3 list online components > redirect to a file f2
  4 grep from the list if desired component / objmgr requested from MP exists in f2 //
  grep “<component>” f2
  5 If
  {the component exists send the output s2=1 to mp }
  else
  {send the status s1=0 to mp }
}
Client program 18 on machine 12:
Program CorrectionM1
{
1.take request from MP with parameters - servername/ ip and Object manager name.
2. Modify File name which is used by P to connect to server to reflect the available server
and object manager name.
}
```

Referring now to FIG. 2, a more detailed diagram of a computerized implementation 30 of the present invention is shown. As depicted, implementation 30 includes a monitoring system 34 deployed within a computer infrastructure 32. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 32 is intended to demonstrate that some or all of the components of implementation 30 could be deployed, managed, serviced, etc. by a service provider who offers to monitor client programs 18 and 20A-B.

As shown, monitoring system 34 includes a processing unit 36, a memory 38, a bus 40, and input/output (I/O) interfaces 42. Further, monitoring system 34 is shown in communication with external I/O devices/resources 44 and storage system 46. In general, processing unit 36 executes computer program code, such as monitoring program 50, which is stored in memory 38 and/or storage system 46. While executing computer program code, processing unit 36 can read and/or write data to/from memory 38, storage system 46, and/or I/O interfaces 42. Bus 40 provides a communication link between each of the components in monitoring system 34. External devices 44 can comprise any devices (e.g., keyboard, pointing device, display, etc.) that enable a user to interact with monitoring system 34 and/or any devices (e.g., network card, modem, etc.) that enable monitoring system 34 to communicate with one or more other computing devices.

Computer infrastructure 32 is only illustrative of various types of computer infrastructures for implementing the invention. For example, in one embodiment, computer infrastructure 32 comprises two or more computing devices (e.g., a server cluster) that communicate over a network to perform the various process steps of the invention. Moreover, monitoring system 34 is only representative of various possible computer systems that can include numerous combinations of hardware. To this extent, in other embodiments, monitoring system 34 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 36 may comprise a single processing unit, or be distributed across one or more processing units in one or more locations, e.g., on a client and server. Similarly, memory 38 and/or storage system 46 can comprise any combination of various types of data storage and/or transmission media that reside at one or more physical locations. Further, I/O interfaces 42 can comprise any system for exchanging information with one or more external devices 44. Still further, it is understood that one or more additional components (e.g., system software, math co-processing unit, etc.) not shown in FIG. 2 can be included in monitoring system 34. However, if monitoring system 34 comprises a handheld device or the like, it is understood that one or more external devices 44 (e.g., a display) and/or storage system(s) 46 could be contained within monitoring system 34, not externally as shown.

Storage system 46 can be any type of system (e.g., a database) capable of providing storage for information under the present invention such as operational group data, analysis data, etc. To this extent, storage system 46 could include one or more storage devices, such as a magnetic disk drive or an optical disk drive. In another embodiment, storage system 46 includes data distributed across, for example, a local area network (LAN), wide area network (WAN) or a storage area network (SAN) (not shown). Although not shown, additional components, such as cache memory, communication systems, system software, etc., may be incorporated into monitoring system 34. It should also be understood that although not shown for brevity purposes, machine 12, clients 14A-B and server 16A include computer components similar to monitoring system 34.

Shown in memory 38 of monitoring system 34 is monitoring program 50, which includes connection monitoring system 52, problem detection system 54, analysis system 56, group selection system 58, communication system 60, and connection switching system 62. It should be understood that although a certain configuration of systems has been depicted for monitoring program 50, the same functionality could be implemented with a different arrangement. Regardless of the configuration, these systems provide the functionality of the present invention discussed above, and further discussed in the illustrative scenarios described below. Specifically, connection monitoring program 52 will monitor a state of client programs 18 and 20A-B, which establish “network” connections to server 16A via connection components C1-C4. In monitoring client programs 18 and 20A-B, connection monitoring system 52 can monitor and/or record a stream of data that is exchanged between client programs 18 and 20A-B and connection components C1-C4 pursuant to the connections therebetween. If the stream of data ceases or exhibits unusual activity, problem detection system 54 can register a “problem” or connection issue. Detection of unusual activity can be based upon a comparison of the data stream to “normal” activity (e.g., as stored in storage system 46).

When a problem is registered, analysis system 56 will analyze the characteristics thereof and provide a summary of the problem to group selection system 58. Specifically, analysis system 56 will examine/determine details of the connections/problem such as the timing of the problem, the nature of the problem (e.g., such as whether communications ceased, were slow, failed entirely), etc. A summary of details can then be provided to group selection system 58, which will select at least one operational group 63 that is best fit to solve the problem. In a typical embodiment, the group 63 selected is a developer group, a networking group, an environment group, and/or an administrator group. When at least one group is selected, communication system 60 will output details of the analysis including the problem and/or pertinent characteristics to the selected group(s). In addition, in the event that it appears as if a connection component C1 is failing, connection switching system 62 can instruct client programs 18 and 20A-B to switch to another connection component C2-C4 (on the same or another server). This could be determined, for example, in the event that multiple client programs are having difficulty establishing or maintaining a connection with the same connection component. Along these lines, the present invention provides a predictive monitoring function in that if a connection between a client program (e.g., 20A) and a particular certain connection component C1-C4 is determined to be potentially failing, any other client program 18, 20B can be switched/instructed to another not attempt connection to that connection component, but rather, switch to another connection component (e.g., on server 16A or any other server).

### Specific Scenarios

Specific scenarios of the present invention will now be described in conjunction with a series of flow charts. In a first illustrative scenario, server program 28A is permitted to be run on server 16A, and monitoring program 50 has access thereto.

In this example, t11 is a return values from a telnet_status function. Specifically, if the telnet (e.g., on port 2320) to server 16A was successful it returns 1, else 0. Show below is illustrative code for the telnet_status function:

telnet_status( )
{
check if command - telnet <server> <port> has been successful -
// port used here is generally 2320
// a failure of command would say connection failed or server not found or
any similar method.
if
{successful status code t11 =1 }
else
{ status code t11 = 0}
.....
}

Further, p11 is the status obtained from a client program 18 or 20A-B. If the connection is successful through program 18 the status p11=1, else 0. Shown below is illustrative code for this function:

```
import com.siebel.data.*;
import com.siebel.data.SiebelException;
public class Status{
static boolean val=false;
static int p11=0;
  public static int code( siebelserver, appobjmgr) {
    SiebelDataBean m_dataBean = new SiebelDataBean( );
    try {
val=m_dataBean.login(“siebel.tcpip.none.none://GatewayServer:
<port>/EnterpriseName/“ + appobjmgr +”, siebelserver , +
“userid”,“password” ,“lang”);
  if(val )
    System.out.println(“Successful Connection”);
    p11=1;
      m_dataBean.logoff( );
        m_dataBean=null;
  return(p11);
  }
}
```

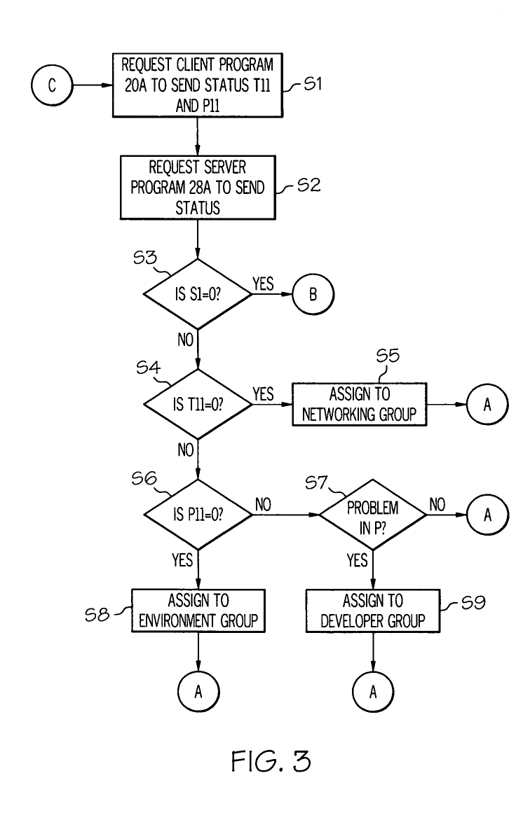

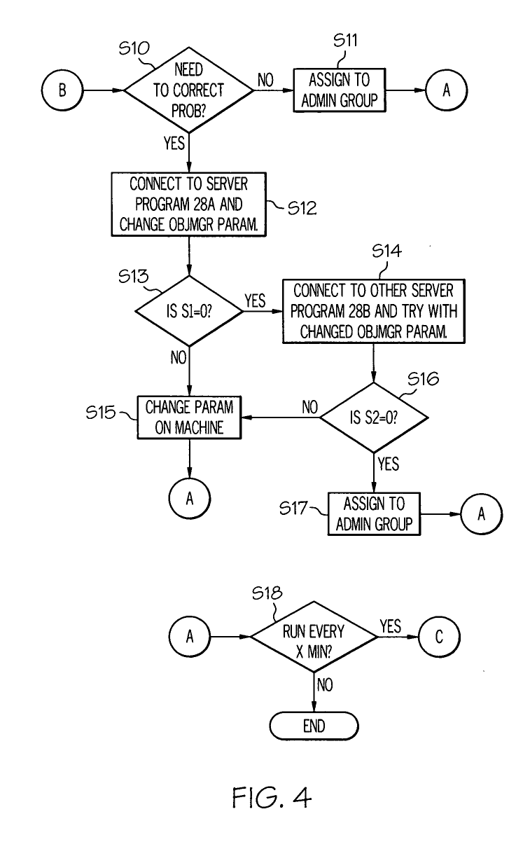

Referring now to FIGS. 3 and 4, a first illustrative scenario will be described. In step S1, client program 20A is requested to send status t11 and p11 to monitoring program 26. In step S2, server program 28A is requested to send status s1 to monitoring program 26. In step S3, it is determined whether s1=0. If so, the process proceeds to flow B of FIG. 4. If not, the process proceeds to step S4, where it is determined whether t11=0. If so, the problem is assigned to the networking group in step S5, and the process proceeds to flow A of FIG. 4. If t11 does not equal 0 in step S4, it s determined in step S6 whether p11=0. If not, it is determined in step S7 whether a problem was reported in client program 18 of machine 12. If not, the process proceeds to flow A of FIG. 4. If so, the problem is assigned to the developer group in step S9 before the process proceeds to flow A. If, however, p11 did not equal 0 in step S6, the problem is assigned to the environment group in step S8 before the process proceeds to flow A.

Referring to FIG. 4, flows A-C can be seen in greater detail. As depicted, in step S10, it is determined whether monitoring program 26 needs to correct the problem. If not, the problem is assigned to the administrator group in step S11 before the process proceeds to flow A. If the monitoring program 26 does need to correct the problem, a connection to server program 26A is established and the objmgr parameter is changed. Thereafter, it is determined whether s1=0 in step S13. If so, a connection to another server program 26B is established and the objmgr parameter therein is changed in step S14. In step S16, it is determined whether s2=0. If not, parameters are changed on machine 12 to point to a server and component that has worked successfully in step S15, which is the same step that is implemented if S1 does not equal 0 in step S13. If, however, S2 does not equal 0 in step S16, the problem is assigned to the administrator group in s17. As further shown in FIG. 4, from flow A, it is determined in step S18 whether this process should be run every X minutes. If not, the process is ended. If so, the process returns to flow C of FIG. 3.

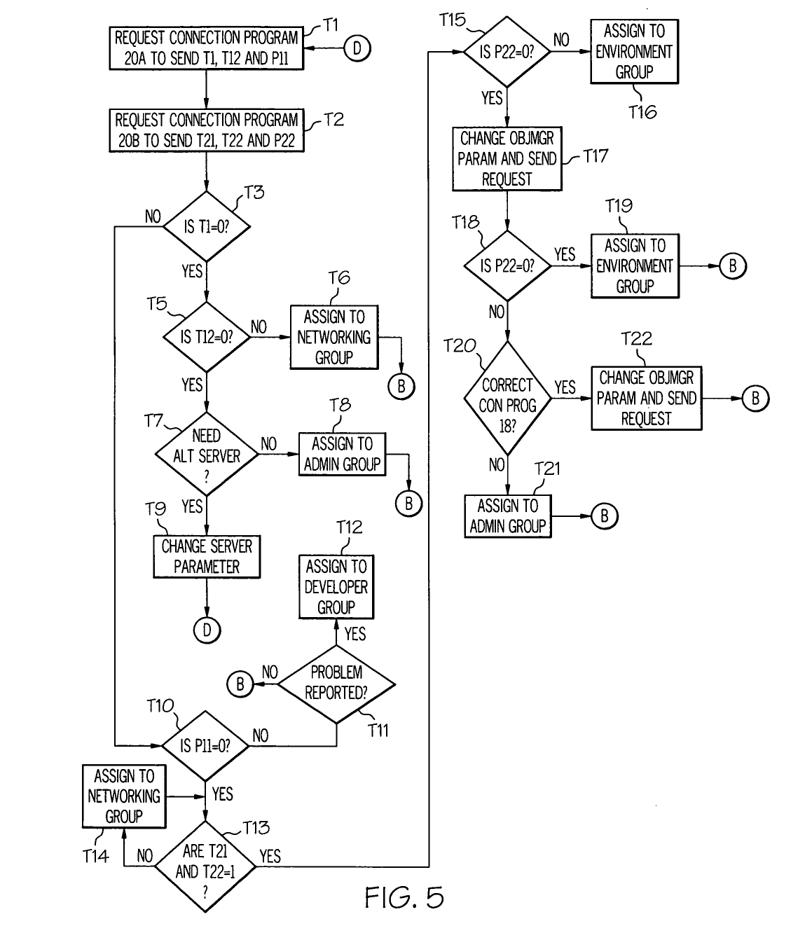

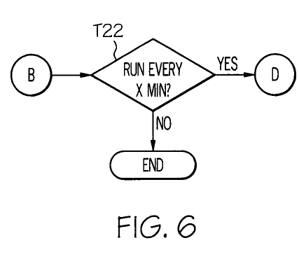

Referring now to FIGS. 5 and 6, a second illustrative scenario is shown. In step T1, client program 20A is requested to send status t11, t12 and p11 to monitoring program 26. In step T2, client program 20B is requested to send status t21, t22 and p22 to monitoring program 26. In step T3, it is determined whether t1=0. If not, the process proceeds to step Tb. If t1=0, it is determined whether t12=0, if not the problem is assigned to the networking group in step T6 before the process proceeds to flow B of FIG. 6. If, however, t12=0, it is determined whether monitoring program should look for an alternate server in step T7. If not, the problem is assigned to an administrator group in step T8 before the process proceeds to flow B of FIG. 6. If an alternate server is needed, the server parameter is changed on machine 12 in step T9 before the process proceeds to flow B of FIG. 6.

In step T10 (from step T3), it is determined whether p11=0, if not it is determined whether a problem was reported in client program 18 in step T11. IF no problem was reported, the process flows to process B. If a problem was reported, it is assigned to the developer group in step T12. If, however, p11=0 in step T1 it is determined whether t21 and t22=1 in step T13. If not, the networking team is requested to resolve the problem on client 14B so that t21 and t22=1 in step T14. Once they do, it is determined in step T15 whether p22=0. If not, the problem is assigned to the environment group in step T16. If, however, p22=0 in step T15, the objmgr parameter is changed and a request is sent to client program 20B in step T17. Then, in step T18, it is determined whether p22=0. If so, the problem is assigned to the environment group in step T19 before the process proceeds to flow B. However, if p22 does not equal 0, it is determined whether monitoring program 26 should attempt to correct the problem in step T20. If so, the objmgr parameter is changed on machine 12 in step T20 before the process proceeds to flow to B. If monitoring program 26 should not attempt to correct the problem, the administrator group is assigned in step T21 before the process proceeds to flow B. As shown in FIG. 6, from flow B, it is determined whether the process should be run every X minutes. If not, the process ends. If so, the process proceeds to flow D.

While shown and described herein as a method and system for monitoring client programs, it is understood that the invention further provides various alternative embodiments. For example, in one embodiment, the invention provides a computer-readable/useable medium that includes computer program code to enable a computer infrastructure to monitor client programs. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 38 (FIG. 2) and/or storage system 46 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to monitor client programs. In this case, the service provider can create, maintain, support, etc., a computer infrastructure, such as computer infrastructure 32 (FIG. 2) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for monitoring client programs. In this case, a computer infrastructure, such as computer infrastructure 32 (FIG. 2), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as monitoring system 34 (FIG. 2), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for monitoring client programs in a client-server environment, comprising:
monitoring a client program on each of a set of clients with a monitoring program loaded on a problem detection computer, wherein each of the set of clients connects to one of a set of connection components on a server;
detecting a problem with an operation of one of the client programs with the monitoring program;
analyzing characteristics of the problem with the monitoring program; and
selecting an organizational group to resolve the problem based on the analyzing.

2. The method of claim 1, wherein the organizational group is selected from an organizational group consisting of a developer group, a networking group, an environment group, and an administrator group, and wherein the analyzing comprises:
determining whether the problem is a networking problem;
determining whether the problem is a developer problem;
determining whether the problem is an environment problem; and
determining whether the problem is an administrator problem.

3. The method of claim 1, wherein the client program is a subset of a larger program loaded on a computer in communication with the server, and wherein the set of connection components comprise Siebel connection components.

4. The method of claim 1, further comprising communicating the problem and the characteristics to the organizational group.

5. The method of claim 1, wherein the monitoring program is adapted to communicate with and obtain information from each of the client programs.

6. The method of claim 1, further comprising:
monitoring a status of the set of connection components on the server for potential failure with the monitoring program; and
avoiding a connection failure of one of the set of clients by switching from a potentially failing connection component to a functioning connection component prior to failure of the potentially failing connection component.

7. The method of claim 6, wherein the avoiding comprises switching to a functioning connection component on another server.

8. A system for monitoring client programs in a client-server environment, comprising:
a connection monitoring system for monitoring a client program on each of a set of clients with a monitoring program loaded on a problem detection computer, wherein each of the set of clients connects to one of a set of connection components on a server;
a problem detection system for detecting a problem with an operation of one of the client programs with the monitoring program;
an analysis system for analyzing characteristics of the problem with the monitoring program; and
a group selection system for selecting an organizational group to resolve the problem based on the analyzing, wherein the organizational group is selected from an organizational group consisting of a developer group, a networking group, an environment group, and an administrator group.

9. The system of claim 8, and wherein the system for analyzing determines whether the problem is a networking problem, whether the problem is a developer problem, whether the problem is an environment problem, and whether the problem is an administrator problem.

10. The system of claim 8, wherein the client program is a subset of a larger program loaded on a computer in communication with the server.

11. The system of claim 8, further comprising a communication system for communicating the problem and the characteristics to the organizational group.

12. The system of claim 8, wherein the monitoring program is adapted to communicate with and obtain information from each of the client programs.

13. The system of claim 8, wherein the connection monitoring system monitors a status of a set of connections to the server for potential failure with the monitoring program, and wherein the system further comprises a connection switching system for avoiding a connection failure of one of the set of clients by switching from a potentially failing connection component to a functioning connection component prior to failure of the potentially failing connection component.

14. The system of claim 13, wherein the connection switching system switches to a functioning connection component on another server.

15. A program product stored on a computer useable medium for monitoring client programs in a client-server environment, the computer useable medium comprising program code for causing a computer system to perform the following steps:
monitoring a client program on each of a set of clients with a monitoring program loaded on a problem detection computer, wherein each of the set of clients connects to one of a set of connection components on a server;
detecting a problem with an operation of one of the client programs with the monitoring program;
analyzing characteristics of the problem with the monitoring program; and
selecting an organizational group to resolve the problem based on the analyzing, wherein the organizational group is selected from an organizational group consisting of a developer group, a networking group, an environment group, and an administrator group.

16. The program product of claim 15, and wherein the analyzing comprises determining whether the problem is a networking problem, whether the problem is a developer problem, whether the problem is an environment problem, and whether the problem is an administrator problem.

17. The program product of claim 15, wherein the computer useable medium further comprises program code for causing the computer system to perform the following step: communicating the problem and the characteristics to the organizational group.

18. The program product of claim 15, wherein the monitoring program is adapted to communicate with and obtain information from each of the client programs.

19. The program product of claim 18, wherein the monitoring comprises monitoring a status of a set of connections to the server for potential failure with the monitoring program; and wherein the computer useable medium further comprises program code for causing the computer system to perform the following step: avoiding a connection failure of one of the set of clients by switching from a potentially failing connection component to a functioning connection component prior to failure of the potentially failing connection component.

20. A method for monitoring client programs in a client-server environment, comprising:
providing a computer infrastructure being operable to:
monitor a client program on each of a set of clients with a monitoring program loaded on a problem detection computer, wherein each of the set of clients connects to one of a set of connection components on a server;
detect a problem with an operation of one of the client programs with the monitoring program;
analyze characteristics of the problem with the monitoring program; and
select an organizational group to resolve the problem based on the analyzing, wherein the organizational group is selected from an organizational group consisting of a developer group, a networking group, an environment group, and an administrator group.
